(19) United States
(12) Patent Application Publication
(10) Pub. No.: US 2024/0070235 A1
(43) Pub. Date: Feb. 29, 2024

(54) AUTOMATED MEDIA TOKENIZATION AND ASSOCIATION

(71) Applicant: Wincast Corp., Brooklyn, NY (US)

(72) Inventors: Noah Diskin Kline, Brooklyn, NY (US); Keith Hudnall, San Diego, CA (US)

(21) Appl. No.: 18/240,897

(22) Filed: Aug. 31, 2023

Related U.S. Application Data
(60) Provisional application No. 63/374,191, filed on Aug. 31, 2022.

(51) Int. Cl. G06F 21/10; G06V 20/40

(52) U.S. Cl. CPC G06F 21/1065; G06V 20/44; G06V 20/49

(57) ABSTRACT

Various implementations for systems and methods of automated media tokenization and association, the method comprising receiving a media stream depicting a media event and metadata associated with the media stream, segmenting a media segment from the media stream, generating a media token based on the media segment from the media stream, minting the media token to a rarity level, and providing the minted media token with the rarity level to a user device for presentation to a user.

### BACKGROUND

This application relates to the creation and assignment of non-fungible tokens (“NFTs”). For example, technologies described in this application may use automatedly generated media-based tokens and provide automated collection in a secure manner.

Currently, people collect various items, such as stamps, coins, or other items as a hobby and investment. Many people collect baseball cards, autographs, or other sports paraphernalia. For example, someone may purchase a rare baseball card of their favorite baseball player from an auction house.

Many sports events are televised on television or streaming platforms. Individuals may temporarily record sports programs on a local digital video recorder; however, these platforms do not allow the individuals to collect, own, sell, and invest in the recordings. Unfortunately, there is not currently an efficient way to collect portions of a streaming or other media event.

### SUMMARY

According to one innovative aspect of the subject matter in this disclosure, systems and methods of automated media tokenization and association are described. In some aspects, the techniques described herein relate to a computer-implemented method including: receiving, by one or more processors, a media stream depicting a media event and metadata associated with the media stream; segmenting, by the one or more processors, a media segment from the media stream; generating, by the one or more processors, a media token based on the media segment from the media stream; minting, by the one or more processors, the media token to a rarity level; and providing the minted media token with the rarity level to a user device for presentation to a user.

In some aspects, the techniques described herein relate to a computer-implemented method, wherein generating the media token based on the media segment further includes: generating a frame that surrounds at least a portion of the media token and enhances a presentation of the media segment; and storing the frame with metadata of the media token such that when the media token is presented for display to a user, the frame is presented surrounding at least a portion of the media token.

In some aspects, the techniques described herein relate to a computer-implemented method, wherein generating the frame further includes generating one or more animations that further enhance the presentation of the media segment.

In some aspects, the techniques described herein relate to a computer-implemented method, wherein the one or more animations include one or more of a highlighting of the frame, a movement of the frame, and a changing of the frame as the media token is presented to a user.

In some aspects, the techniques described herein relate to a computer-implemented method, wherein the media token is a non-fungible token (NFT) stored in a blockchain.

In some aspects, the techniques described herein relate to a computer-implemented method, wherein segmenting the media segment from the media stream further includes: automatically segmenting the media segment from the media stream as the media stream is presented in substantially real-time.

In some aspects, the techniques described herein relate to a computer-implemented method, wherein the media stream is automatically segmented based on one or more criteria being met, the one or more criteria include one or more of a viewership threshold, a schedule of the media stream, a game winning attempt, a record-breaking moment, and a detected audience noise level being exceeded.

In some aspects, the techniques described herein relate to a computer-implemented method, wherein the rarity level of the media token is presented on the media token as a graphical image.

In some aspects, the techniques described herein relate to a computer-implemented method, further including: detecting that the media token has been used during an event; updating a history of the media token to include that the media token has been used during the event; and updating metadata of the media token to reflect that the media token has been used during the event.

In some aspects, the techniques described herein relate to a media token generation system including: one or more processors; and one or more memories storing instructions that, when executed by the one or more processors, cause the system to perform operations including: receiving a media stream depicting a media event and metadata associated with the media stream; segmenting a media segment from the media stream; generating a media token based on the media segment from the media stream; minting the media token to a rarity level; and providing the minted media token with the rarity level to a user device for presentation to a user.

In some aspects, the techniques described herein relate to a media token generation system, wherein generating the media token based on the media segment further includes: generating a frame that surrounds at least a portion of the media token and enhances a presentation of the media segment; and storing the frame with metadata of the media token such that when the media token is presented for display to a user, the frame is presented surrounding at least a portion of the media token.

In some aspects, the techniques described herein relate to a media token generation system, wherein generating the frame further includes generating one or more animations that further enhance the presentation of the media segment.

In some aspects, the techniques described herein relate to a media token generation system, wherein the one or more animations include one or more of a highlighting of the frame, a movement of the frame, and a changing of the frame as the media token is presented to a user.

In some aspects, the techniques described herein relate to a media token generation system, wherein the media token is a non-fungible token (NFT) stored in a blockchain.

In some aspects, the techniques described herein relate to a media token generation system, wherein segmenting the media segment from the media stream further includes: automatically segmenting the media segment from the media stream as the media stream is presented in substantially real-time.

In some aspects, the techniques described herein relate to a media token generation system, wherein the media stream is automatically segmented based on one or more criteria being met, the one or more criteria include one or more of a viewership threshold, a schedule of the media stream, a game winning attempt, a record-breaking moment, and a detected audience noise level being exceeded.

In some aspects, the techniques described herein relate to a media token generation system, wherein the rarity level of the media token is presented on the media token as a graphical image.

In some aspects, the techniques described herein relate to a media token generation system, wherein the one or more processors are configured to perform the operations including: detecting that the media token has been used during an event; updating a history of the media token to include the use of the media token during the event; and updating metadata of the media token to reflect the use of the media token during the event.

In some aspects, the techniques described herein relate to a computer-implemented method including: receiving, by one or more processors, a media file representing a media event and metadata associated with the media file; segmenting, by the one or more processors, the media file into a plurality of media segments; providing, by the one or more processors, the media event including an indication of at least one of the plurality of media segments for display on one or more client devices; receiving, by the one or more processors, one or more user inputs including a bid associated with the at least one media segment; determining, by the one or more processors, a ranking of the bid using the one or more user inputs; compositing, by the one or more processors, a clip based on the at least one media segment and the ranking of the bid; generating, by the one or more processors, a non-fungible token using the composited clip and based on the ranking of the bid; and transferring, by the one or more processors, ownership of the generated non-fungible token to a digital wallet of a user associated with the bid.

In some aspects, the techniques described herein relate to a computer-implemented method, wherein the media file representing a media event is received as the media event is being presented in substantially real-time and the media file is segmented into a plurality of media segments as the media event is being presented in substantially real-time.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is an example of a system for automated media token generation.

FIG. 2 is a block diagram illustrating an example computer system for interacting with generated media tokens.

FIG. 3 is a graphical representation of an example media stream for automated media token generation.

FIG. 4 is a graphical representation of an example of generating a media token from a media stream.

FIG. 5 is a graphical representation of an example media token automatedly generated from a media stream.

FIG. 6 is a graphical representation of an example of procuring an automatedly generated media token from a media stream.

FIG. 7 is a flowchart of an example method of automatedly generating a media token from a media stream.

FIGS. 8A and 8B are flowcharts of an example method of transferring an automatedly generated media token.

### DETAILED DESCRIPTION

The present disclosure relates to systems and methods for automated media tokenization and association. Implementations of the technology provide improved systems and methods for integrating and automating one or varied computing systems. In some implementations, the technology may allow for automated creation of collections of media clips, for example, using blockchain technologies, such as non-fungible tokens (“NFT”). For example, copyright owners of sports media (e.g., a baseball game) may provide authorization and/or use the technology described herein to allow collection of some or all of the programs, such as in the form of media segments, etc.

In some implementations, the technology described herein may automatically segment media clips, which may be live or pre-recorded events, into individually collectable segments that may be transferred to different users using a database, such as a distributed database like a blockchain or other immutable database to allow for tracking of the segmented media clips. In some implementations, the technology may allow for automated generation of media tokens of a single media segment into multiple media tokens with varying levels of rarity generated by the system. These differing levels of media tokens with varying rarities may then be transferred to various users as collectibles, such as NFTs, etc. For instance, a user may wish to collect a clip or NFT of a media event depicting when a baseball player breaks the homerun record or of a knock-out blow in a boxing match. Furthermore, this media segment may be very valuable if only one or a limited number are in existence. For example, when the segments are minted into NFTs, they may be sold to other collectors and using the blockchain, the NFTs may be validated to ensure only a limited number of the collectible media segments may be used.

In some implementations, where multiple NFTs exist, they may be generated with varying levels of rarity upon generating of the multiple NFTs. For example, the technology may automatically generate and/or mint various NFTs of a single clip and may assign the various NFTs at different rarity levels, such as with differing graphical depictions of the various NFTs. For example, a first level of rarity may have a static or video (e.g., a GIF) frame, introduction, template, filter, resolution, frame rate, or another attribute. Similarly, in another example, a second, third, etc., level may have various other attributes differentiating them. The technology may automatically generate and mint various quantities of each level. For instance, in one example, a platinum level may have a single NFT (e.g., with a generated frame indicating its level or other attributes, such as a highest resolution or frame rate), a gold level may have 2 NFTs, a silver level may have 3 NFTs, and a bronze level may have 4 NFTs. The levels may each have various generated frames, resolutions, quantities, or other attributes differentiating them when the media tokens are generated. It should be noted that other quantities, attributes, levels, or other features may be varied while still using the technologies described herein.

In some implementations, the technology may automatically receive bids, process the bids to determine segments, rarities, and users, and then automatically generate and mint NFTs corresponding to the segment, rarity, and/or user. For example, the system may automatically determine that a certain user won a bid on a certain media segment, add a frame (or other attributes) during generation that indicates a tier/level/value/rarity to the media segment, generate an NFT of the media segment, verify a digital wallet of the user, and transfer ownership of the NFT to the user's wallet.

Beneficially, the technologies described herein provides advanced automation and integration among multiple systems, such as a server of a media provider, a client device displaying media, a server for generating NFTs, and/or other systems. While previously NFTs were manually created for entire media, the technologies described herein can automatically subdivide media, such as media streams, into sub-segments, composite the sub-segments together with frames or other attributes (e.g., reflecting value or rarity), generate and mint the composite files into NFTs, and provide them to designated wallets. The technologies beneficially process media files into digital clips into digital tokens, which may be collected in ways not previously possible with physical collectables and in ways not previously performed using computers.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

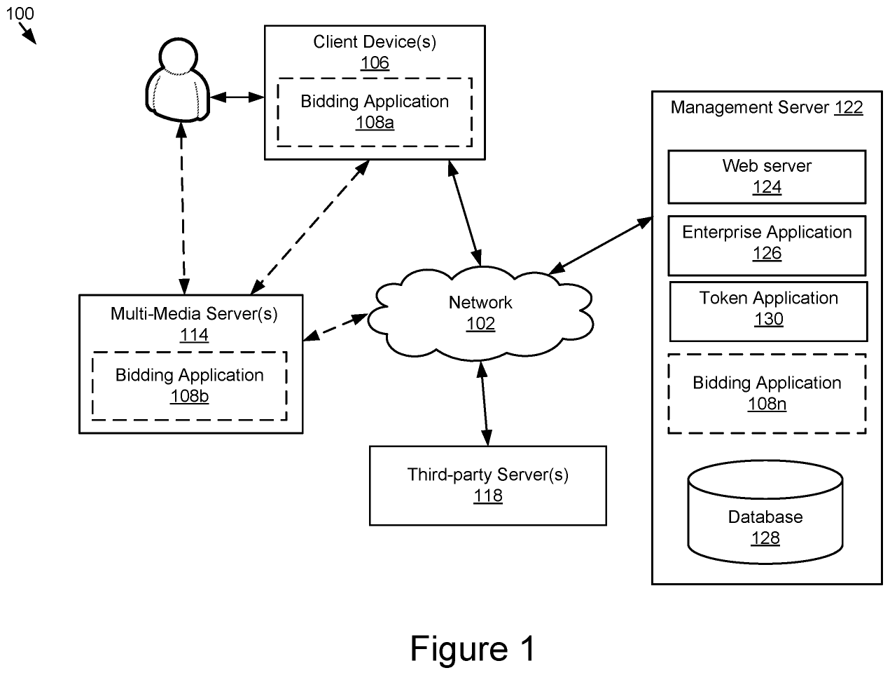

FIG. 1 is a block diagram of an example system 100 for providing automated media tokenization and association. The illustrated system 100 may include one or more client devices 106, a third-party server 118, a management server 122, and/or multi-media server(s) 114, which may run instances of the bidding application 108a . . . 108n and which may be electronically communicatively coupled via a network 102 for interaction with one another, although other system configurations are possible including other devices, systems, and networks. For example, the system 100 could include any number of client devices 106, multi-media servers 114, third-party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., multiple client devices 106 may be used by a single participant, multiple participants, stakeholders, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, tablets, laptops, desktops, netbooks, server appliances, servers, virtual machines, TVs, etc. The system 100 may include any number of client devices 106, including client devices 106 of the same or different type.

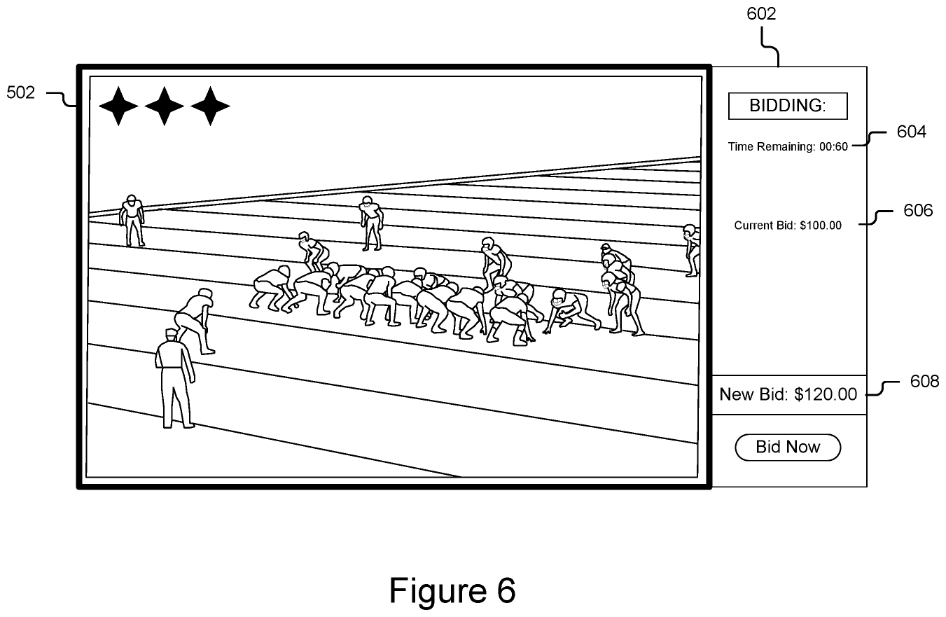

In some implementations, one or multiple client devices 106 may be used with a bidding application 108. A user may stream media from a management server 122 using a first client device 106 on which an instance or component of the bidding application 108 provides graphical elements indicating a bidding segment and/or receiving inputs from the user, for example, bidding on a segment. In some instances, the client device may additionally or alternatively store keys for NFTs (e.g., the bidding application may automatically transfer an NFT to the device's/user's wallet), cryptocurrency, encrypted files, or other files. For example, the bidding application 108 may stream or otherwise display media, such as a boxing match in a frame (e.g., an iframe, etc.) or media player and provide, adjacent to the media player (e.g., as illustrated in the examples herein) interaction elements, such as indicators of a specific sub-segment (e.g., a bar or timeline, a series of previews, timestamps, etc.), such as those shown in FIG. 6, a timer indicating the end of a sub-segment, an end of a bidding period, a current bid price, a rarity, or other details. In some implementations, with the media, the bidding application 108 may display a bidding field via which the user may provide a maximum bid amount or other information. The interaction elements may receive input via a curser interaction (e.g., where the client device 106 is a personal computer), a voice or remote control interaction (e.g., where the client device 106 is a smart television), a touch screen input (e.g., where the client device 106 is a smart phone or tablet), or a physical gesture (e.g., where the client device 106 is a virtual or augmented reality device).

In some implementations, multiple client devices 106 may be used. For instance, a multi-media server 114 may stream a media event, such as a boxing match to a television of a user and the user may interact with the bidding application 108 on a separate client device 106, multi-media server 114, third-party server 118, or management server 112. For instance, the multi-media server 114 may stream the media to a television along with a QR code, which the user can scan on via their smartphone/client device 106. Based on a live timing of the media stream and/or a synchronization with the media on the television with the bidding application 108 on (e.g., executed on or accessed via) the smartphone, the user may bid on and collect the media segments displayed on the TV. For instance, the television may display the media stream while a smartphone provides interaction elements via which the user may select, bid on, and collect the tokenized media segments. The smartphone may display the timeline of available segments and receive inputs allowing the user to collect the segments.

In some implementations, where the multi-media server 114 and/or management server 122 are streaming data via a streaming application on a smart television, a user may connect their client device 106 (e.g., a smartphone), bidding account, or wallet to the application, which may cause the television's streaming application to change modes when collection of/bidding on segments for the displayed media is available. For example, the television or other client device may display data, such as a current bid, a segment timing, or other details relating to collecting media segments, such as is illustrated in the example graphical interfaces herein.

The management server 122 and its components may aggregate information about and provide data associated with the systems and processes described herein to a multiplicity of users on a multiplicity of client devices 106, for example, as described in reference to various users and client devices 106 described herein. In some implementations, a single user may use more than one client device 106, which the management server 122 as described above, or multiple users may use multiple client devices to interact with an individual media segment, for example, as when they are bidding against each other or otherwise on the same segment. In some implementations, the management server 122 may communicate with and provide information to a client device 106.

One or more multi-media servers 114 may be communicatively coupled with a client device 106, management server 122, and/or network 102. For example, a multi-media server 114 may stream media, such as a baseball game or boxing match to a client device 106 or television either directly or via the management server 122. For example, the multi-media server 114 may be a third-party device that streams live or transmits previously recorded video to the management server 122, which may transcode the media, segment or determine segments for the media, upload and/or provide media access, and perform other operations, such as those described herein.

In some implementations, the bidding application 108 may send information to another computing device, for example, to a management server 122 or third-party server 118. For example, the bidding application 108 may determine certain information and communicate with various devices based on those details. For instance, the bidding application 108 may perform the various operations described herein.

The management server 122 may include a web server 124, an enterprise application 126, a token application 130, a bidding application 108, and a database 128. In some configurations, the enterprise application 126 and/or bidding application 108 may be distributed over the network 102 on disparate devices in disparate locations or may reside in the same location. The client device 106a and/or the management server 122 may each include an instance of the bidding application 108 and/or portions/functionalities thereof. The client devices 106 may also store and/or operate other software such as a bidding application 108, an operating system, other applications, etc., that are configured to interact with the management server 122 via the network 102.

The management server 122, multi-media server 114, and/or the third-party server 118 have data processing, storing, and communication capabilities, as discussed elsewhere herein. For example, the servers 114, 118, and/or 122 may include one or more hardware servers, server arrays, storage devices and/or systems, etc. In some implementations, the servers 114, 118, and/or 122 may include one or more virtual servers, which operate in a host server environment.

In some implementations, the enterprise application 126 may receive communications from a client device 106 in order to perform the functionality described herein. The enterprise application 126 may receive information and provide information to the bidding application 108 to generate adaptable graphical interfaces described, as well as perform and provide analytics and other operations. In some implementations, the enterprise application 126 may perform additional operations and communications based on the information received from client devices 106, as described elsewhere herein.

In some implementations, the token application 130 may include software and/or logic configured to receive a media stream, such as a real-time media stream, segment the media stream, ingest the media stream, generate a media token such as an NFT, and/or mint the media token. In some implementations, the token application 130 generates the media token using an automated process that may automatically segment portions of a media stream based on one or more attributes of the media stream, such as a level of the media stream (e.g., a championship game, playoff, final match, etc.), an amount of users viewing the media stream, a historical significance of the media stream (e.g., a record breaking moment depicted in the media stream, a winning shot/point, etc.), or other variables that may be used to determine when a media stream should be segmented. In some implementations, the token application 130 may automatically generate the media token based on the segments and the generating of the media token may include adding graphical representations to the media token, such as a frame or border, flair, rarity indicators, banners, descriptions, captions, etc. In some implementations, the token application 130 may mint the media token such as by determining a rarity or value for the media token. The rarity may be based on how many segments of the media token should be made available and what rarity levels the one or more media tokens should be minted as. In some implementations, such as where the media token is an NFT, the minting includes linking the media token to the blockchain so that the history and validity of the media token can be confirmed and preserve the rarity of the minting. In further implementations, as a media token is used, such as being traded, presented, or interacted with at different events, additional minting of the media token may occur. For example, a user may own a media token of a player scoring a game winning shot and may later present that media token at a subsequent event where a player scores another game winning shot. Since the user was present at the second game winning shot, the token application 130 may be able to verify the details and supplement the initial media token with additional information/metadata to further increase a value or rarity of the media token. This allows for the media tokens to be generated in a first instance and then as the media token is used over time, the history of the media token may allow for additional information, such as metadata or graphical depictions, to be further minted with the media token to track the media tokens updated history. In another implementation, in a gamification aspect of the media token, when the media token is used in a game application, the media token may be further minted with the aspects of the media tokens used in the game application.

The database 128 may be stored on one or more information sources for storing and providing access to data, such as the data storage device 208. The database 128 may store data describing client devices 106, instances of the bidding application 108, media segments, composite data files, metadata, preferences, configurations, NFTs, user wallet data, and other information, such as described herein.

A third-party server 118 can host services such as a third-party application (not shown), which may be individual and/or incorporated into the services provided by the management server 122. For example, the third-party server 118 may represent one or more item databases, forums, company websites, etc. For instance, a third-party server 118 may provide automatically delivered and processed data, such as frames, attributes, media segments, and/or services, such as media processing services, NFT-creating services, or other services.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

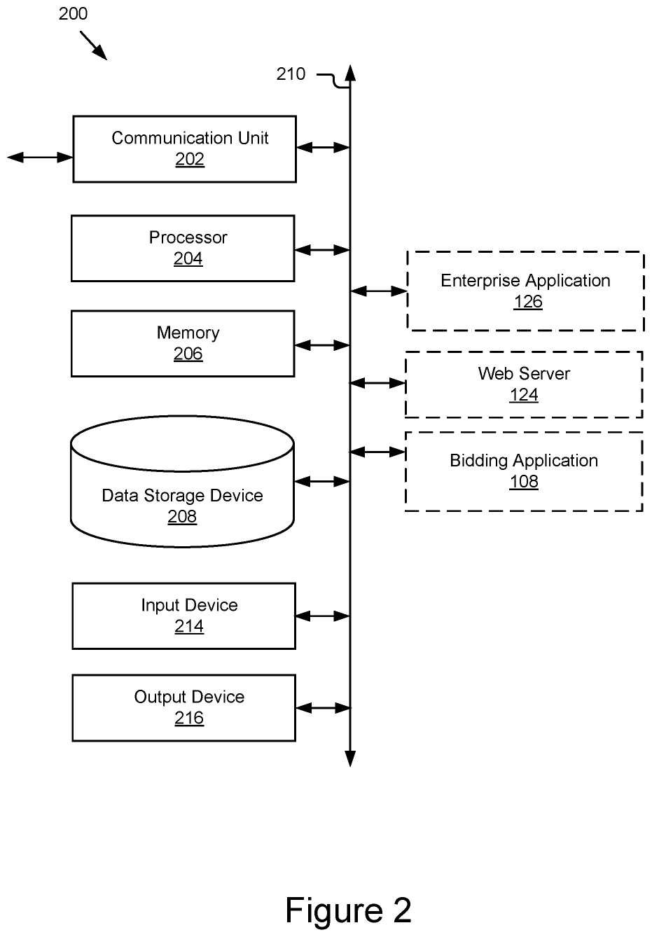

FIG. 2 is a block diagram of an example computing system 200, which may represent computer architecture of a client device 106, third-party server 118, multi-media server 114, management server 122, and/or another device described herein, depending on the implementation. In some implementations, as depicted in FIG. 2, the computing system 200 may include an enterprise application 126, a web server 124, a bidding application 108, or another application, depending on the configuration. For instance, a client device 106 may include or execute a bidding application 108 (which could incorporate various aspects of the enterprise application 126 and/or the token application 130, in some implementations); and the management server 122 may include the web server 124, the enterprise application 126, and/or components thereof, although other configurations are also possible and contemplated.

The enterprise application 126 includes computer logic executable by the processor 204 to perform operations discussed elsewhere herein. The enterprise application 126 may be coupled to the data storage device 208 to store, retrieve, and/or manipulate data stored therein and may be coupled to the web server 124, the bidding application 108, and/or other components of the system 100 to exchange information therewith.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 to determine the content, retrieve and incorporate data from the data storage device 208, format the content, and provide the content to the client devices 106.

In some instances, the web server 124 may format the content using a web language and provide the content to a corresponding bidding application 108 for processing and/or rendering to the user for display. The web server 124 may be coupled to the data storage device 208 to store retrieve, and/or manipulate data stored therein and may be coupled to the enterprise application 126 to facilitate its operations.

The bidding application 108 includes computer logic executable by the processor 204 on a client device 106 to provide for user interaction, receive user input, present information to the user via a display, and send data to and receive data from the other entities of the system 100 via the network 102. In some implementations, the bidding application 108 may generate and present user interfaces based on information received from the enterprise application 126, the multi-media server 114, third-party server 118, and/or the web server 124 via the network 102. For example, a customer/user may use the bidding application 108 to perform the operations described herein.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the bidding application 108, and their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, bidding application 108, and various other components operating on the computing system/device 100 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, microphone, an image/video capture device (e.g., camera), a touch-screen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, media providers, rarity levels, wallet data, blockchain data, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

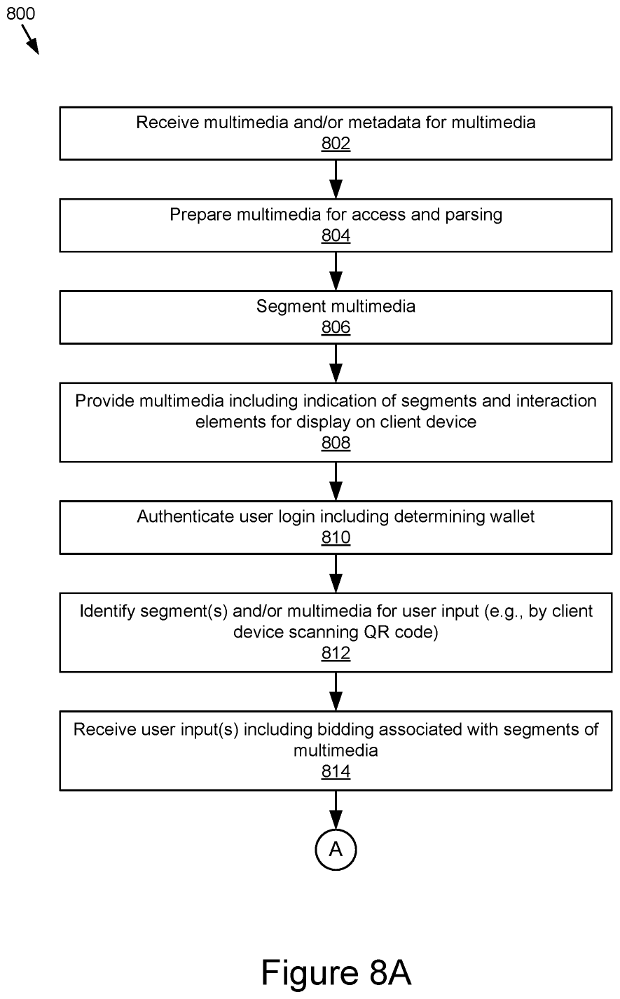

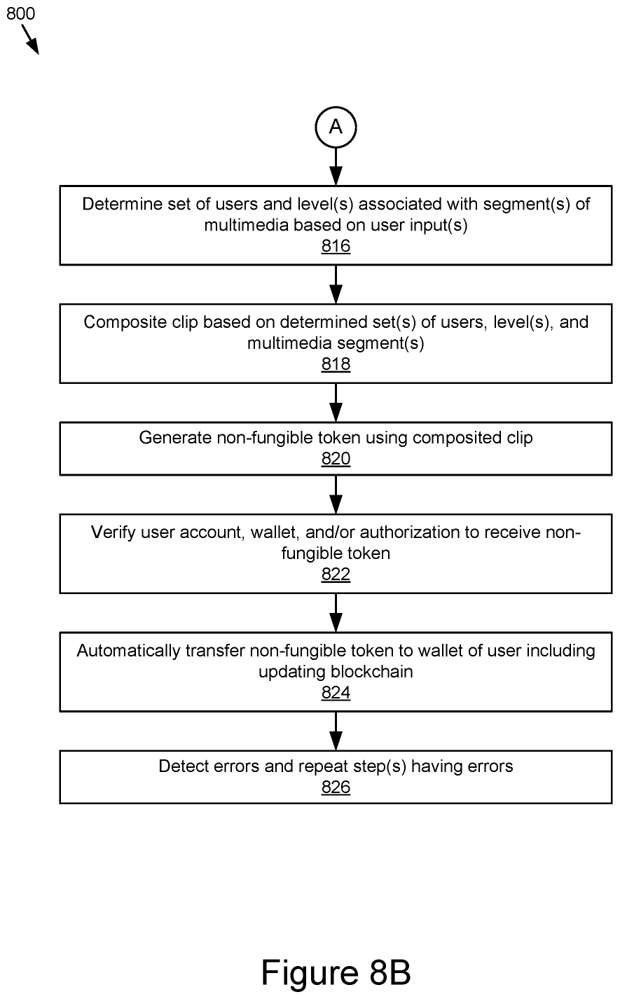

FIGS. 8A-8B illustrate a flowchart of an example method 800 for automated media tokenization and association. It should be noted that other operations, orders, and features are contemplated herein. For instance, the technology may use fewer, additional, or different operations or orders of operations than those described herein without departing from the scope of this disclosure. It should be noted that although the operations of the method 800 are described in reference to the bidding application 108, they may be performed by different components of the system 100, distributed, or otherwise modified without departing from the scope of this disclosure.

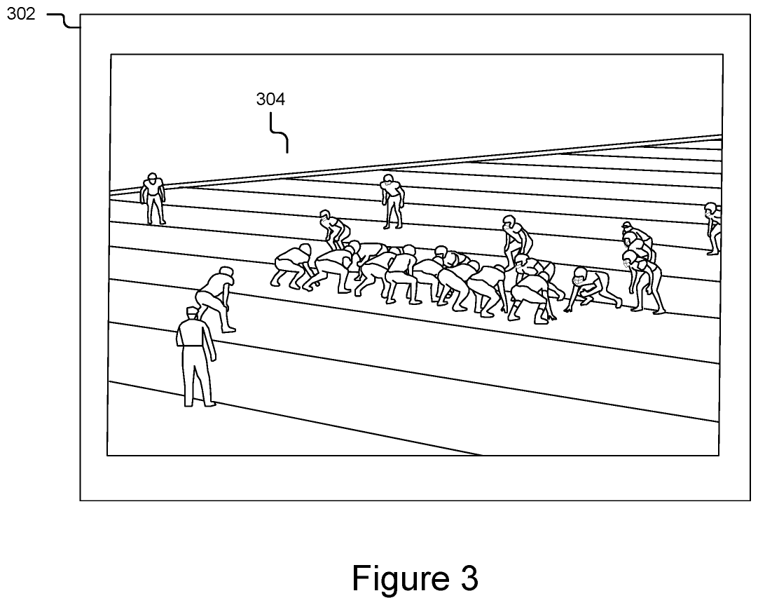

FIG. 3 illustrates an example graphical representation of a media stream 304 being displayed on a device 302, such as a TV, smartphone, etc. As shown in the example in FIG. 3, a media event, such as a football game, etc. is being presented on device 302, which may be a client device 106 or another device where a multimedia stream can be displayed. As shown, the media stream 304 may be presented in some implementations in substantially real-time. As the user watches the media stream 304, the token application 130 may segment one or more portions of the media stream 304.

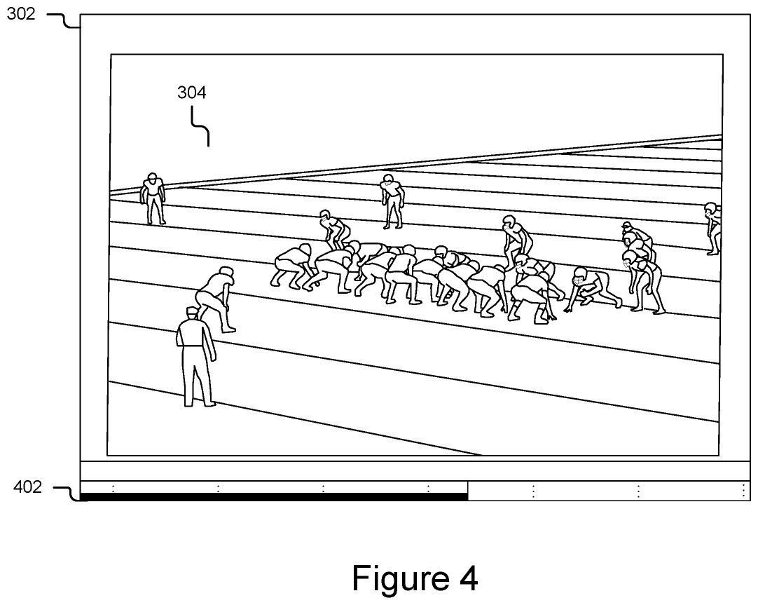

FIG. 4 illustrates an example graphical representation of the media stream 304 being segmented as shown by the segmenting panel 402. In some implementations, the segmenting panel 402 may be displayed, such as for manual segmentation of the segment of the media stream 304 for media tokenization. In further implementations, the segmenting may be performed in an automated fashion by the token application 130 as described elsewhere herein and the segmenting panel 402 is not displayed. Once the token application 130 has segmented a portion of the media stream 304, the segment can used to generate a media token by the token application 130. The segment can be turned into the media token by linking the media token data to the blockchain, such as by creating an NFT of the media token.

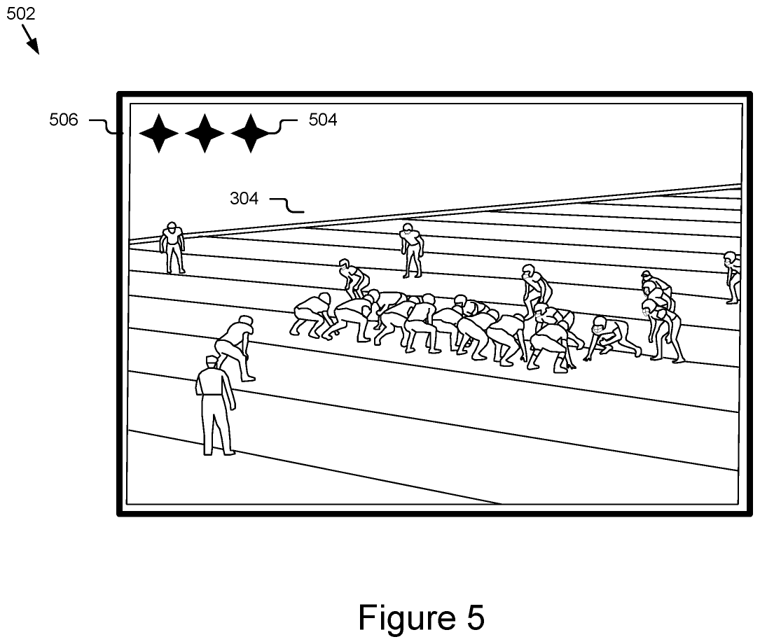

FIG. 5 illustrates an example graphical representation of the media stream 304 being minted to form a media token 502. In some implementations, the token application 130 may take the segmented media token 502 and mint the segmented media token 502 to form the NFT. The minting may include adding metadata such as graphical layouts, such as a frame 506 that enhances the representation of the media token 502. The frame 506 may be a border or other layout that enhances how the media token 502 is depicted when viewed. In some implementations, the frame 506 may be animated and may change or highlight various portions of the media token as it is viewed, such as glowing or shimmering when a significant event occurs within the media token 502, such as a winning shot going through the basket or a tackle being broken, etc. In some implementations, the token application 130 may also include a rarity depiction 504, such as stars indicating a rarity, or colors (e.g., bronze, silver, gold, platinum, etc.) to depict the rarity. In some implementations, the media token 502 by be further updated with additional metadata, such as reminting the media token 502 when an update occurs in the event history of the media token 502, etc.

FIG. 6 illustrates an example bidding interface for transferring a media token 502. As illustrated, a media token 502 may be displayed including data or metadata about the event, overlays 602 indicating that a segment/bidding round is beginning, active, ending, or ended. In some implementations, such as is illustrated on the right side of FIG. 6, an interaction area/interaction elements may include an indication of a maximum bid, a current bid 606, a bid increment 608, a projected tier, a cost per tier or token, a current rank, a projected rank, a final rank, a time remaining 604 in the bidding process, or other data. The interaction area may allow the user to enter and place an absolute or maximum bid. A user can gain ownership of the media token 502 by placing a winning bid through the bidding application 108. As depicted in FIG. 6, in some implementations, the bidding application 108 may allow a user to bid on a media token 502 as the real-time event is being presented. For example, a final play of a football match during a tie game may be about to start and before the play starts, the bidding application 108 may open to allow users to potentially bid on the future media token before the play has even started. This allows for a real-time bidding as the media stream segment is created and potentially creates additional value in the future media token 502 as the play begins and the results of the play are shown in substantially real-time. In some implementations, the play may result in a winning score creating a valuable media token 502, while in other implementations, the play may result in no score which may be a less valuable media token 502. Users may gamble on the value of the media token 502 as the user bids while the play occurs.

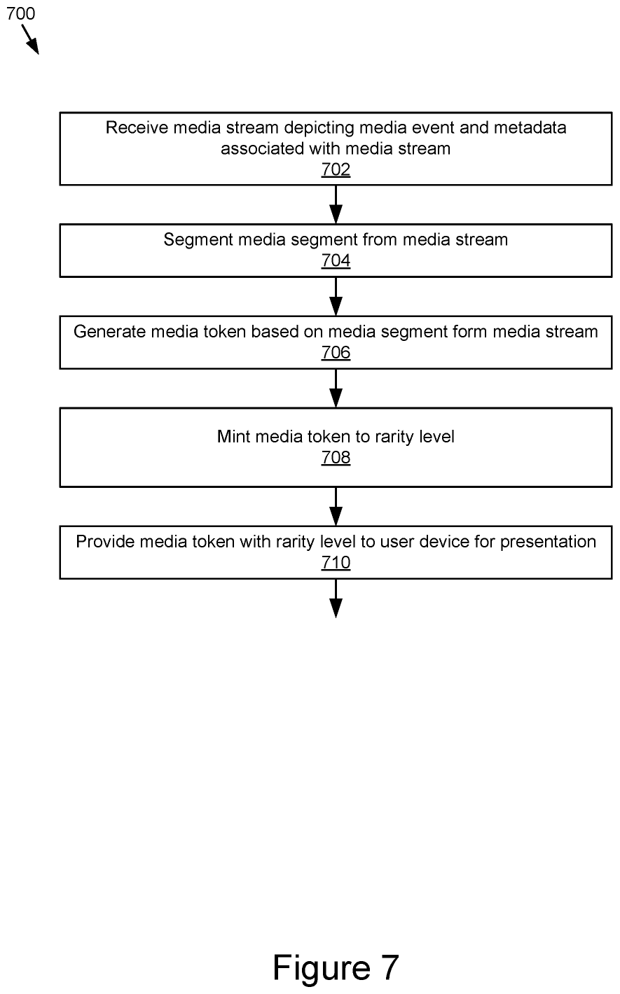

FIG. 7 is a flowchart 700 of an example computer-implemented method of generating a media token. At 702, the token application 130 receives a media stream depicting a media event and metadata associated with the media stream. The media event may be a real-time event, such as a sporting event, concert, political function, news broadcast, etc. or the media event may be a prerecorded event that is being presented to a user for viewing. The metadata associated with the media stream may include whether the event is live, participants included in the event, event information such as attendance, noise levels, location, date, ticket purchases, etc. The metadata may further include context around the event, such as if a player is close to breaking a record for points scored, if the event has championship or playoff implications, etc.

At 704, the token application 130 segments a media segment from the media stream. In some implementations, the segment may be an image or a short video clip that depicts at least a portion of what was/is being presented in the media stream. In some implementations, the token application 130 may begin the segmenting process as the media stream occurs in real-time meaning a start of a segment is initiated at one point in substantially real-time and an end of the segment is initiated at a later point in substantially real-time and the segment is segmented as the media stream is presented in substantially real-time. In some implementations, the segmenting by the token application 130 may be an automated segmentation based on one or more criteria that may be obtained from the metadata provided in substantially real-time, such as a viewership threshold, a schedule of the media stream, a game winning attempt, a record-breaking moment, and/or a detected audience noise level being exceeded. The token application 130 may use these criteria to begin segmenting a media segment when a criteria is met, satisfied, or exceeded that may depict an important moment of the media stream that user may be interested in collecting as a media token.

At 706, the token application 130 may generate a media token based on the media segment from the media stream. In some implementations, generating the media token may include transforming the media segment to include one or more enhancements that become part of the media token. The one or more enhancements may include a frame, a border, a graphical image overlaying at least a portion of the media segment, an animation such as a movement of the frame, a changing of the frame, a zooming on an a portion of the media segment, and/or a highlighting of the frame or other feature on the media token (such as a wiggle or flair to enhance the media token), a graphical image depicting a rarity level or color coded level of the media token, a color change of the media token, such as grayscale or changing tones to highlight one or more aspects of the media token, etc. In some implementations, generating the media token may include generating a frame that surrounds at least a portion of the media segment to increase the viewable appeal of the media token. In some implementations, generating the media token may further include saving the media token in a format to link the media token to the blockchain to preserve a history and/or validate the media token at a later time.

At 708, the token application 130 can mint a media token to a rarity level. Minting the media token may include determining a rarity level of the token based on one or more factors, such as a popularity of the media segment depicted by the media token, a real-time bidding history showing an interest in the media token, a historical significance of the media segment depicted in the media token, a quantity of media tokens depicting the same or similar media segments (e.g., if only a single media token depicts the event, then the rarity may be higher), a color or animation level of the media token (e.g., a media token generated with a platinum enhancement may have a higher rarity level than a media token generated with a bronze enhancement). The token application 130 may store the rarity level with other metadata associated with the media token in the blockchain for validation and media token history.

At 710, the token application 130 may provide the media token with the rarity level to a user device 106 for presentation. In some implementations, the media token may be transferred to a user so that a user can view and/or interact with the media token as it is presented on their user device 106. In some implementations, the media token may be stored in a user's digital wallet or access may be provided when the user provided credentials to access and/or view/interact with the media token stored in a database 128. In some implementations, the media token may be presented on a user device 106 for a user to bid on transfer of the media token as described elsewhere herein.

The features and operations described herein, for example, in reference to FIGS. 8A-8B provide operations for streaming media, creating clips (potentially in real time), collecting clips using NFTs, etc. For example, the operations of the method 800 provides automation and integration in ways that have not previously been performed, for example, by allowing segments of streaming, live, or pre-recorded media (e.g., audio, video, etc.) to be collected, for instance, in the form of an NFT. The operations of the method 800 may use graphical user interfaces, such as those provided herein, to provide media, information relating to the media, and/or receive user inputs. As discussed above, previous methods were too slow and inefficient to process data streams for media, especially where the segments are composited and minted into NFTs. Accordingly, the overall method and automation described herein allow functionality that was not previously possible or performed.

In some implementations, at 802, the bidding application 108 may receive multimedia and/or metadata for the multimedia. For instance, an administrative user may use administrative graphical user interfaces, such as those described below, to establish a connection with media streams (e.g., by downloading it, associating it, or providing access to it via a multi-media server 114) and provide, receive, or confirm certain data regarding the media stream. In some implementations, an administrator may create an event, indicate a segment length, define an event type, set a title, set a runtime, indicate available tiers/levels of NFTs, define royalties, prices for positions, minimum bids, minimum bid increments, or various other details, as described elsewhere herein, while in other implementations, these attributes may be automatically implemented, such as based on various machine learning algorithms from models and information provided by administrators, etc.

In some implementations, the media stream may be received as a pre-recorded event, for example, as a media file that may be distributed to client devices via management server 122. In some implementations, the media stream may be streamed to the management server 122 and/or client device(s) 106 (e.g., as described above) from a multi-media server 114, third-party server 118, and/or management server 122. As described below, processing of the pre-recorded and/or streaming media may be performed in real-time or, potentially, upon completion of a segment and/or entire media program (e.g., video or audio, etc.).

In some implementations, at 804, the token application 130 may prepare the multimedia stream for access and parsing. For instance, the token application 130 may create a stream URL, transcode (or use a third-party server 118 to transcode), upload media or media segments/sub-segments to an S3 bucket, or perform other processing to allow the media stream to be viewed and/or processed into segments, etc.

In some implementations, at 806, the token application 130 may segment the multimedia. For instance, the token application 130 (e.g., an instance or component thereof operable on a management server 122) may determine segments for the media to segment into media tokens, for example, based on the defined metadata or other attributes. The segments may be any defined or determined (e.g., dynamically determined) length, whether static or varying. For example, the segments may be a static length (e.g., 10 minutes, 10 seconds, etc.), set based on events in the media (e.g., innings, time between commercials), set manually, or otherwise. In some implementations, the token application 130 may automatically segment the media stream based on various attributes, such as duration, popularity, viewing statistics, other attributes, etc. and may incorporate those automated segmentations based on machine learning algorithms of the segmenting process from training models of previous segments generated over time.

In some implementations, as the media stream is played (e.g., a live event), an administrator may manually define a segment or shorten it. For live events, the segmentation may be automatically or manually performed as described elsewhere herein. For instance, an administrator may manually input a starting or ending point, which is then propagated to the token application 130. During the media event, the administrator may override pre-set lengths and the token application 130 may automatically display a timeline, preview, countdown to an end point, or other data to users viewing the event and/or bidding on it. For example, if the media event is a boxing match and there is a knock-out, an administrator may mark the end of a segment, which may start a countdown (e.g., 10 seconds, 60 seconds, 10 minutes, etc.) to the end of the bidding on the segment marked at an end, where the countdown may be displayed adjacent to the media clip in a graphical interface. This allows for users to bid on a media token in substantially real-time as a media token is literally being shown and/or generated. This creates an additional level of rarity for various media tokens as the tokens are only available for transfer or purchase for a short duration as the media stream is being presented in real-time and shortly after historical moments in the media stream are presented.

For a pre-recorded event, the segments may be manually defined, for example, their lengths or beginning/ending times may be set based on their values or interesting moments in an event.

In some implementations, at 808, the bidding application 108 may provide the multimedia, such as the media stream, including an indication of the segment(s) and interaction elements for display on a client device 106. Example graphical interfaces, streams, and/or interaction elements are illustrated in reference to the figures herein. In some implementations, the interaction elements may be displayed separately from the media, for example, where the media is played on a television while the interaction elements (e.g., for bidding, viewing segments, etc.) are displayed on a client device 106, such as a smartphone.

In some implementations, the segments may be indicated on the media and/or a graphical interface (e.g., as a frame, etc.), such as on a timeline or play bar. The timeline may be scrollable or selectable to display previews of the segment.

In some implementations, at 810, the bidding application 108 may authenticate a user login of a user and determine the user's wallet. For instance, the user may log in to the bidding application and, in some instances, associate their digital wallet for paying for and/or receiving NFTs. In some implementations, a custodial wallet may be created and/or associated with the user for receiving the NFT(s). The user may additionally or alternatively provide credit card information, user profile, preferences, or other data.

In some implementations, at 812, the bidding application 108 may identify segment(s) and/or the multimedia, e.g., media stream, for user input. The user may select an event from the bidding application 108 or another application to select the media to view and/or bid on. For instance, the user may log in to the bidding application 108 and select to view a boxing match, which is then served to the client device 106 of the user.

In some implementations, the user may select a specific segment of the media to view and/or interact with. For instance, the user may select a segment/sub-segment on which to bid or otherwise collect.

In some implementations, where the media is displayed on a separate device, such as a television, from the interaction elements, the media and/or segments may be otherwise selected. For example, during the media event/video, a multi-media provider may display a QR code, ID, sound clip, or another identifier that may be used to select the media/segment. For example, the user may scan a QR code on a television, which may cause the bidding application 108 to display interaction elements linked with the media and/or segment in the media.

In some implementations, at 814, the bidding application 108 may receive user input(s) including bidding associated with segment(s) of the multimedia. For instance, the user input may select a segment, indicate a tier/level, input an absolute or minimum bid. For example, the user may input, for a segment, a maximum bid amount. The bidding application 108 (e.g., an instance or component thereof) and/or enterprise application 126 may select, based on the maximum bids of all bidders, along with a minimum bidding increment, a position of each user/bid and associated bid amounts.

In some implementations, at 816, the bidding application 108 may determine a set of users and level(s)/tier(s) associated with the segment(s) of the multimedia based on the received user inputs. For example, the users may be ranked based on their bids.

In some implementations, based on attributes of tiers, such as their quantities, associations with user rank, associations with amounts paid, rarity, or otherwise, each user/bid may be associated with a tier for the segment. For example, a top bidder/bid may be associated with a platinum tier for the segment and a second and third bidder may be associated with a gold tier, etc. Accordingly, the rarity or value of an asset may be assigned to a bidder based on their ranking. As noted above, based on the users, bids, and administrative settings (e.g., in the defined metadata), several available copies/NFTs of a segment may be generated.

In some implementations, at 818, the bidding application 108 may composite a clip based on the determined set(s) of users, level(s)/tier(s), and multimedia segments. The enterprise application or bidding application may process the segments based on their tiers or other attributes in real time when bidding ends, after a defined time, after settlement, at the end of the media/event, or based on another trigger.

Depending on the implementation, the bidding application may access a GIF or frame associated with a level and use it to modify the segment. For example, the bidding or enterprise application may composite a clip with a frame indicating the tier that was won by the user, its rarity, and/or other information. The metadata or visual aspects of the clip may be modified to indicate the tier, etc. For example, the segment may be cut from the rest of the media and framed with a frame for a tier, which may be a looping GIF, static image, various animation, or other data. Accordingly, when the composited clip/segment is replayed/accessed, it may display both the moving media segment and the frame.

In some implementations, at 820, the bidding application 108 may generate a non-fungible token using the composited clip. Various methods may be used for minting the NFT, which may be performed on the management server 122, third-party server 118, multi-media server 114, or client device 106.

In some implementations, at 822, the bidding application 108 may verify a user account, wallet, and/or authorization to receive an NFT. In some implementations, the bidding application (e.g., a component or instance thereof) or enterprise application may verify payment by a user and/or verify an identity of a user's digital wallet.

In some implementations, at 824, the bidding application 108 may automatically transfer the NFT to a wallet of the user, for example, including updating the blockchain, providing keys, transferring files, and/or providing other operations. In some implementations, the user's digital wallet may be stored on a cloud, hot, or cold.

The bidding application 108 may display previews of the items in a user's wallet, for example, by accessing the blockchain to determine the NFTs owned by the user. In some implementations, certain rights and privileges may be provided to the user based the assets they own. For example, if the user has a certain quantity of platinum NFTs, they may receive discounts, exclusive access to events, or other benefits.

In some implementations, the bidding application 108 may allow a user to burn certain tokens in exchange for other assets. For example, the user may burn 2 or 3 gold-tier NFTs in exchange for a platinum NFT.

In some implementations, at 826, the bidding application 108 may detect errors and repeat steps, of the method 800, based on the errors to correct them. For example, the bidding and/or enterprise application may detect an error in the processing of a segment and re-process the step(s) for that error.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats. Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, by one or more processors, a media stream depicting a media event and metadata associated with the media stream;
segmenting, by the one or more processors, a media segment from the media stream;
generating, by the one or more processors, a media token based on the media segment from the media stream;
minting, by the one or more processors, the media token to a rarity level; and
providing the minted media token with the rarity level to a user device for presentation to a user.

2. The computer-implemented method of claim 1, wherein generating the media token based on the media segment further comprises:
generating a frame that surrounds at least a portion of the media token and enhances a presentation of the media segment; and
storing the frame with metadata of the media token such that when the media token is presented for display to a user, the frame is presented surrounding at least a portion of the media token.

3. The computer-implemented method of claim 2, wherein generating the frame further comprises generating one or more animations that further enhance the presentation of the media segment.

4. The computer-implemented method of claim 3, wherein the one or more animations include one or more of a highlighting of the frame, a movement of the frame, and a changing of the frame as the media token is presented to a user.

5. The computer-implemented method of claim 1, wherein the media token is a non-fungible token (NFT) stored in a blockchain.

6. The computer-implemented method of claim 1, wherein segmenting the media segment from the media stream further comprises:
automatically segmenting the media segment from the media stream as the media stream is presented in substantially real-time.

7. The computer-implemented method of claim 6, wherein the media stream is automatically segmented based on one or more criteria being met, the one or more criteria include one or more of a viewership threshold, a schedule of the media stream, a game winning attempt, a record-breaking moment, and a detected audience noise level being exceeded.

8. The computer-implemented method of claim 1, wherein the rarity level of the media token is presented on the media token as a graphical image.

9. The computer-implemented method of claim 1, further comprising:
detecting that the media token has been used during an event;
updating a history of the media token to include that the media token has been used during the event; and
updating metadata of the media token to reflect that the media token has been used during the event.

10. A media token generation system comprising:
one or more processors; and
one or more memories storing instructions that, when executed by the one or more processors, cause the system to perform operations including:
receiving a media stream depicting a media event and metadata associated with the media stream;
segmenting a media segment from the media stream;
generating a media token based on the media segment from the media stream;
minting the media token to a rarity level; and
providing the minted media token with the rarity level to a user device for presentation to a user.

11. The media token generation system of claim 10, wherein generating the media token based on the media segment further comprises:
generating a frame that surrounds at least a portion of the media token and enhances a presentation of the media segment; and
storing the frame with metadata of the media token such that when the media token is presented for display to a user, the frame is presented surrounding at least a portion of the media token.

12. The media token generation system of claim 11, wherein generating the frame further comprises generating one or more animations that further enhance the presentation of the media segment.

13. The media token generation system of claim 12, wherein the one or more animations include one or more of a highlighting of the frame, a movement of the frame, and a changing of the frame as the media token is presented to a user.

14. The media token generation system of claim 10, wherein the media token is a non-fungible token (NFT) stored in a blockchain.

15. The media token generation system of claim 10, wherein segmenting the media segment from the media stream further comprises:
automatically segmenting the media segment from the media stream as the media stream is presented in substantially real-time.

16. The media token generation system of claim 15, wherein the media stream is automatically segmented based on one or more criteria being met, the one or more criteria include one or more of a viewership threshold, a schedule of the media stream, a game winning attempt, a record-breaking moment, and a detected audience noise level being exceeded.

17. The media token generation system of claim 10, wherein the rarity level of the media token is presented on the media token as a graphical image.

18. The media token generation system of claim 10, wherein the one or more processors are configured to perform the operations including:
detecting that the media token has been used during an event;
updating a history of the media token to include the use of the media token during the event; and
updating metadata of the media token to reflect the use of the media token during the event.

19. A computer-implemented method comprising:
receiving, by one or more processors, a media file representing a media event and metadata associated with the media file;
segmenting, by the one or more processors, the media file into a plurality of media segments;
providing, by the one or more processors, the media event including an indication of at least one of the plurality of media segments for display on one or more client devices;
receiving, by the one or more processors, one or more user inputs including a bid associated with the at least one media segment;
determining, by the one or more processors, a ranking of the bid using the one or more user inputs;
compositing, by the one or more processors, a clip based on the at least one media segment and the ranking of the bid;
generating, by the one or more processors, a non-fungible token using the composited clip and based on the ranking of the bid; and
transferring, by the one or more processors, ownership of the generated non-fungible token to a digital wallet of a user associated with the bid.

20. The computer-implemented method of claim 19, wherein the media file representing a media event is received as the media event is being presented in substantially real-time and the media file is segmented into a plurality of media segments as the media event is being presented in substantially real-time.
